(19) United States
(12) Patent Application Publication
(10) Pub. No.: US 2016/0114633 A1
(43) Pub. Date: Apr. 28, 2016

(54) PNEUMATIC TIRE AND METHOD FOR MANUFACTURING THE SAME

(71) Applicant: Toyo Tire & Rubber Co., Ltd., Osaka (JP)

(72) Inventor: Takashi Miyasaka, Osaka-shi (JP)

(73) Assignee: Toyo Tire & Rubber Co., Ltd., Osaka (JP)

(21) Appl. No.: 14/885,306

(22) Filed: Oct. 16, 2015

(30) Foreign Application Priority Data
Oct. 24, 2014 (JP) 2014-217336

(51) Int. Cl. B60C 15/06; C08J 3/26; B29C 53/02; B60C 15/00; B60C 1/00; C08J 3/22; C08K 3/04

(52) U.S. Cl. CPC B60C 15/0632; C08J 3/22; C08J 3/26; C08K 3/04; B60C 15/0009; B60C 1/00; B29C 53/02; C08J 2307/02; B60C 2001/005; B29K 2009/00

(57) ABSTRACT

Separation in a chafer edge is suppressed, thereby improving durability of a bead part. In a pneumatic tire including a bead core embedded in a bead part, a carcass ply folded around the bead core and locked, and a chafer having a reinforcing cord embedded therein arranged so as to cover the carcass ply around the bead core, a rubber sheet is prepared using a wet masterbatch containing natural rubber and/or polyisoprene rubber, and carbon black, and the rubber sheet is interposed between a folded part of the carcass ply and an edge of the chafer overlapping the folded part.

### CROSS-REFERENCE TO RELATED APPLICATIONS

This application is based upon and claims the benefit of priority from the prior Japanese Patent Application No. 2014-217336, filed on Oct. 24, 2014; the entire contents of which are incorporated herein by reference.

### BACKGROUND

1. Technical Field

The present invention relates to a pneumatic tire.

2. Related Art

In a pneumatic tire, the edge of a carcass ply is generally folded from the inside in a tire width direction to the outside around a bead core, and locked. A chafer having a reinforcing cord such as a steel cord or an organic fiber cord embedded therein is sometimes embedded in a bead part in order to reinforce the bead part. Separation sometimes occurs in a pneumatic tire having the chafer embedded in the bead part, particularly, in the edge of the chafer overlapped on the folded part of a carcass ply, by local repeated strain.

To improve durability of a bead part having a chafer provided therein, for example, JP-A-2014-104881 discloses that a soft rubber layer is provided so as to cover the edge of the inside in a tire width direction of the chafer from the inside in a tire width direction. JP-A-2009-101943 discloses that a cushion rubber layer is provided so as to cover the edge of the outside in a tire width direction of a chafer from the outside in a tire width direction in order to suppress separation between a chafer as a reinforcing layer and the neighboring rubber. Those patent documents disclose covering the edge of a chafer with a rubber layer, but do not disclose that a rubber sheet is interposed between the edge of a chafer and a folded part of a carcass.

It is known to use a wet masterbatch us the technology for improving dispersibility of carbon black into a rubber (see JP-A-60-108444, JP-A-2007-197549 and U.S. Pat. No. 8,053,496B1). The wet masterbatch is obtained by mixing a slurry of carbon black with a rubber latex liquid, followed by coagulating and drying. It has not been conventionally known to use such a wet masterbatch in a rubber sheet suppressing separation in the edge of a chafer.

### SUMMARY

An embodiment has an object to improve durability of a bead part by suppressing separation in the edge of a chafer.

A method for manufacturing a pneumatic tire according to an embodiment comprises (i) preparing a rubber sheet using a wet masterbatch containing natural rubber and/or polyisoprene rubber, and carbon black, (ii) interposing the rubber sheet between a folded part of a carcass ply and the edge of a chafer overlapping the folded part in manufacturing a green tire in which the edge of the carcass ply is folded around a bead core and the chafer having a reinforcing cord embedded therein is arranged so as to cover the carcass ply around the bead core, and (iii) vulcanization-molding the green tire obtained.

A pneumatic tire according to an embodiment comprises a bead core embedded in a bead part, a carcass ply folded around the bead core and locked, a chafer in which a reinforcing cord is arranged so as to cover the carcass ply around the bead core, and a rubber sheet interposed between the folded part of the carcass ply and the edge of the chafer overlapping the folded part, wherein the rubber sheet comprises a rubber composition comprising a wet masterbatch containing natural rubber and/or polyisoprene rubber, and carbon black.

According to the embodiment, a rubber sheet having carbon black highly dispersed therein is arranged between the edge of a chafer and a folded part of a carcass ply. This constitution can effectively suppress breakage due to local strain fatigue in the edge of the chafer, and can improve durability of the bead part.

### BRIEF DESCRIPTION OF THE DRAWINGS

FIG. 1 is a semi-sectional view of a pneumatic tire according to a first embodiment.

FIG. 2 is an enlarged cross-sectional view of a bead part in the first embodiment.

FIG. 3 is an enlarged view of a main part in FIG. 2.

FIG. 4 is a conceptual view showing a constitution of a bead part in the first embodiment.

FIG. 5 is an enlarged cross-sectional view of a bead part in a second embodiment.

FIG. 6 is a conceptual view showing a constitution of a bead part in the second embodiment.

FIG. 7 is an enlarged cross-sectional view of a bead part in a third embodiment.

FIG. 8 is a conceptual view showing a constitution of a bead part in the third embodiment.

FIG. 9 is an enlarged cross-sectional view of a bead part in a fourth embodiment.

FIG. 10 is a conceptual view showing a constitution of a bead part in the fourth embodiment.

FIG. 11 is an enlarged cross-sectional view of a bead part in a fifth embodiment.

FIG. 12 is a conceptual view showing a constitution of a bead part in the fifth embodiment.

### DETAILED DESCRIPTION

### First Embodiment

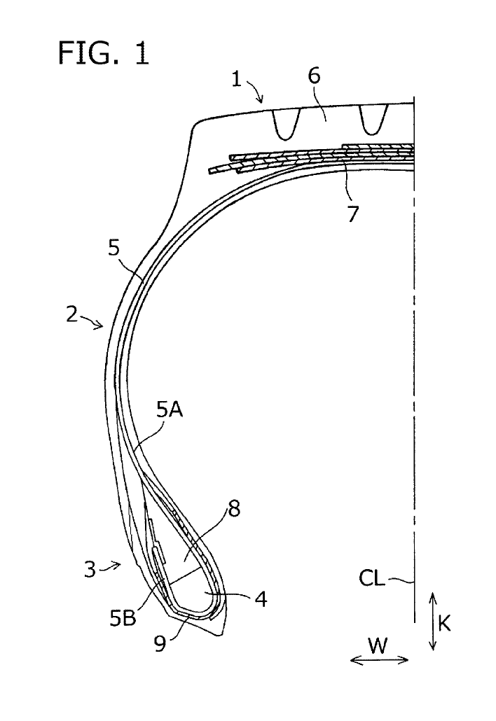

FIG. 1 shows a cross-section of a pneumatic radial tire for heavy load as a pneumatic tire according to one embodiment. This tire comprises a tread part 1, a pair of right and left sidewall parts 2 extending inward in a tire radial direction from both edges of the tread part, and a pair of right and left bead parts 3 provided inside in a tire radial direction of the sidewall parts 2. A ring-shaped bead core 4 is embedded in a pair of the bead parts 3, respectively. In FIG. 1, CL indicates a tire equator, K indicates a tire radial direction, and W indicates a tire width direction (the same as a tire axial direction). Unless otherwise indicated, a “radial direction” means the tire radial direction K, and a “width direction” means the tire width direction W. In this example, the tire has a symmetrical structure with respect to the tire equator CL.

At least one carcass ply 5 toroidally extending between a pair of the bead cores 4 is embedded in the pneumatic tire. In this example, the carcass ply 5 is one, but two or more carcass plies may be provided. The carcass ply 5 extends to the bead part 3 through the sidewall part 2 from the tread part 1, and is locked by folding the edge of the carcass ply 5 around the bead core 4 in the bead part 3. The edge of the carcass ply 5 is folded outside from the inside of a width direction around the bead core 4. The carcass ply 5 comprises a carcass cord comprising a steel cord, an organic fiber cord or the like, and a covering rubber for covering the carcass cord. The carcass cord is arranged at substantially right angle to a tire circumferential direction.

A belt 7 comprising at least two belt plies is provided between the carcass ply 5 and a tread rubber 6 at the outer circumferential side of the carcass ply 5 in the tread part 1.

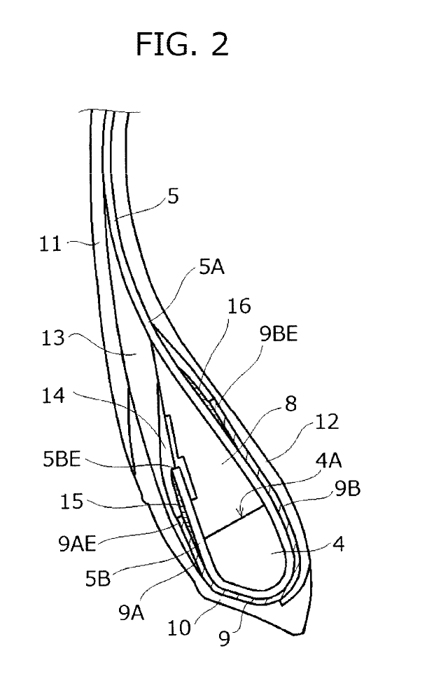

As shown in FIG. 2 as an enlarged view, a bead filler 8 made of hard rubber is provided on the outer circumference of the bead core 4 (that is, the outside in a radial direction) between a main part 5A of the carcass ply 5 and its folded part 5B. The bead filler 8 has a triangular cross-sectional shape in which a width is gradually narrowed toward the outside of a radial direction. The folded part 5B of the carcass ply 5 is provided such that its edge, that is, a folded edge 5BE, is located at the outside in a radial direction of the bead core 4.

A chafer 9 is provided in the bead part 3 so as to cover the carcass ply 5 from the inside of a radial direction. The chafer 9 is a reinforcing layer having a reinforcing cord such as a steel cord or an organic fiber cord embedded therein, and is placed on the surface of the carcass ply 5 so as to cover the carcass ply 5 over the outside of a width direction from the inside thereof around the bead core 4. The chafer 9 is constituted of an outer winding part 9A wound up toward the outside of a radial direction in the outside of a width direction, and an inner winding part 9B wound up toward the outside of a radial direction in the inside of a width direction, on the basis of the inner edge in a radial direction of the bead core 4. Reference numeral 9AE is an edge of the outside in a width direction of the chafer 9 (that is, the edge in the outer winding part 9A), and is terminated between an outer circumferential surface 4A of the bead core 4 and a folded edge 5BE of the carcass ply 5. Reference numeral 9BE is an edge of the inside in a width direction of the chafer 9 (that is, the edge in the inner winding part 9B), and is terminated between the outer circumferential surface 4A of the bead core 4 and an outer edge in a radial direction of the bead filler 8. The chafer 9 is constituted by covering reinforcing cords arranged inclinedly to a radial direction with a covering rubber.

A rubber chafer 10 is provided in the bead part 3 as a rubber part constituting an outer surface part of the portion contacting a rim flange not shown. The rubber chafer 10 constitutes an outer surface part of the bead part coming into contact with the rim flange in the state that a pneumatic tire is mounted on a normal rim, and is also called a rim strip. In more detail, the rubber chafer 10 is provided so as to cover the outer winding part 9A of the chafer 9 from the outside of a width direction, and a sidewall rubber 11 is connected to an outer edge of a radial direction thereof.

Reference numeral 12 represents an inner liner as a gas barrier rubber layer provided on the inner surface of a tire. The inner liner 12 is provided so as to cover the inner winding part 9B of the chafer 9 from the inside of a width direction, and is terminated at the inside in a radial direction of the bead core 4. The terminal part is covered with the rubber chafer 10.

Reference numeral 13 represents a rubber pad filling a space formed between the rubber chafer 10 and sidewall rubber 11 constituting an outer surface part of the bead part 3, and the bead filler 8 in the inside of its width direction. An inner edge in a radial direction of the pad 13 extends up to the position covering the outer winding edge 9AE of the chafer 9.

Reference numeral 14 represents a rubber pad arranged so as to fill level difference on the outside in a radial direction of the outer winding edge 9AE of the chafer 9. That is, the robber pad 14 is a rubber member filling level difference formed on an outer circumference of the outer winding edge 9AE due to a thickness of the chafer 9, and is arranged on the outside in a radial direction of the outer winding edge 9AE.

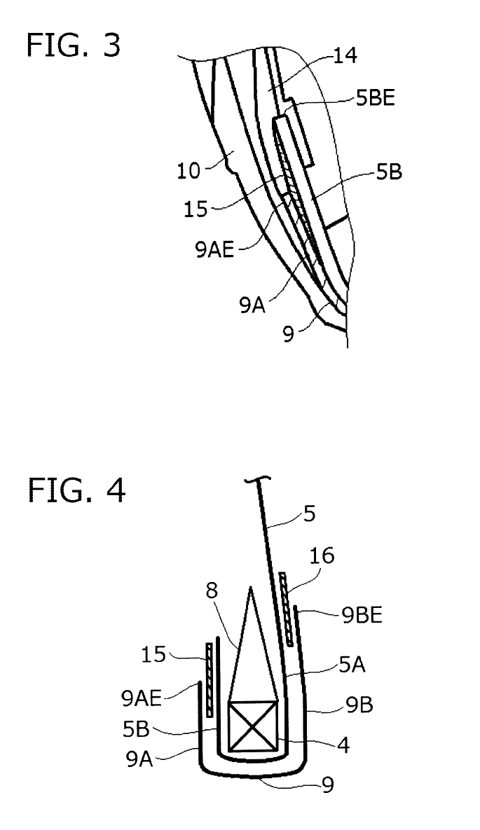

As shown in FIG. 3 as an enlarged view; a rubber 15 is interposed between the folded part 5B of the carcass ply 5 and the outer winding edge 9AE of the chafer 9 overlapping the folded part 5B (also see FIG. 4). In the present embodiment, a rubber sheet comprising a rubber composition containing a wet masterbatch containing natural rubber and/or polyisoprene rubber, and carbon black is used as the rubber sheet 15. Thus, fatigue resistance performance can be improved by forming the rubber sheet 15 using a wet masterbatch having carbon black highly dispersed therein. As a result, separation due to strain generated in the outer winding edge 9AE of the chafer 9 can be suppressed.

The rubber sheet 15 comes into contact with the folded part 5B of the carcass ply 5 and the outer winding edge 9AE of the chafer 9, and is sandwiched therebetween. The rubber sheet 15 exceeds the outer winding edge 9AE and extends toward the outside of a radial direction along an outer surface of the folded part 5B.

In the present embodiment, a similar rubber sheet 16 is also interposed between the main part 5A of the carcass ply 5 and the edge of the chafer 9 (that is, the inner winding edge 9BE) overlapping the main part 5A. Thus, regarding the inner winding edge 9BE, separation due to strain generated in the inner winding edge 9BE of the chafer 9 can be suppressed by providing the rubber sheet 16 prepared using the wet masterbatch.

### Second Embodiment

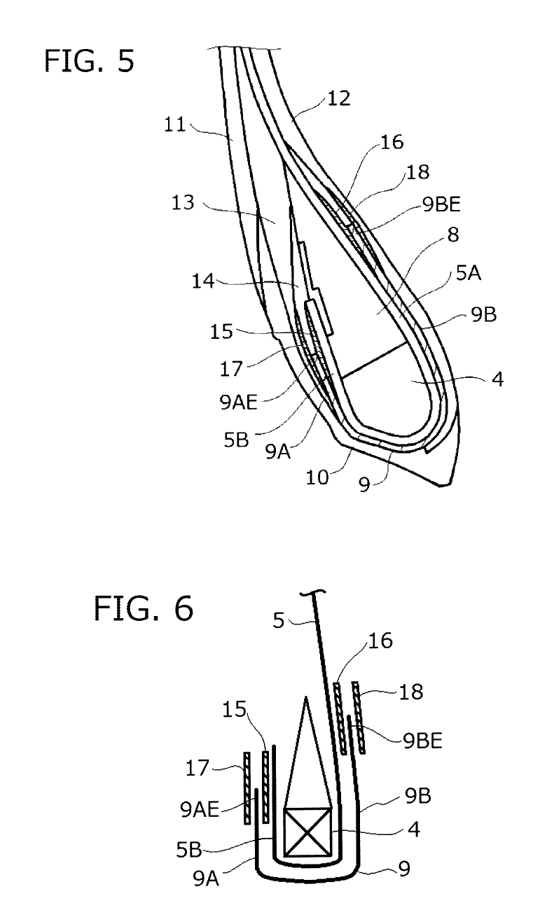

The second embodiment is characterized in that an additional rubber sheet is inserted in the structure of the first embodiment. In the second embodiment, the rubber sheets 15 and 16 in the first embodiment are used as first rubber sheets, and second rubber sheets 17 and 18 are arranged so as to sandwich the edges 9AE and 9BE of the chafer 9 between the first rubber sheets 15 and 16 and the second rubber sheets 17 and 18, as shown in FIG. 5 and FIG. 6.

In detail, in the outer winding edge 9AE of the chafer 9, the first rubber sheet 15 is adhered to the inside in a width direction thereof, and the second rubber sheet 17 is adhered so as to cover the outer winding edge 9AE from the outside of a width direction. The second rubber sheet 17 is interposed between the outer winding edge 9AE and the pad 13. The second rubber sheet 17 exceeds the outer winding edge 9AE and extends toward the outside of a radial direction.

In the inner winding edge 9BE of the chafer 9, the first rubber sheet 16 is adhered to the outside in a width direction thereof, and the second rubber sheet 18 is adhered so as to cover the inner winding edge 9BE from the inside of a width direction. The second rubber sheet 18 is interposed between the inner winding edge 9BE and the inner liner 12. The second rubber sheet 18 exceeds the inner winding edge 9BE and extends toward the outside of a radial direction.

In the second embodiment, separation due to strain generated in the edges 9AE and 9BE of the chafer 9 can be more effectively suppressed by using rubber sheets prepared using the same wet masterbatch as in the first rubber sheets 15 and 16 as the second rubber sheets 17 and 18. Other structures in the second embodiment are the same as in the first embodiment and the description thereof is omitted.

### Third Embodiment

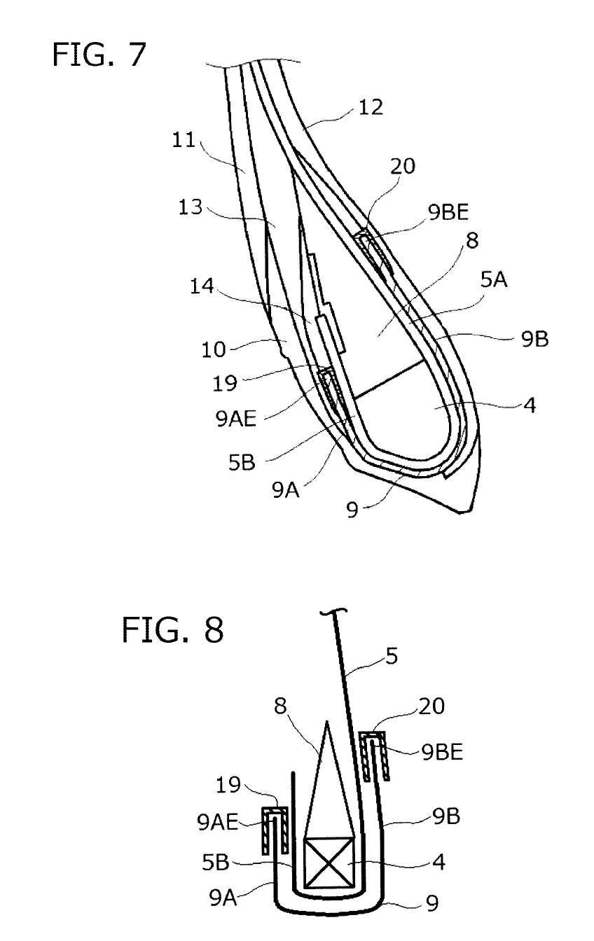

The third embodiment is characterized in that the rubber sheet is arranged so as to wrap the edge of the chafer in the structure of the first embodiment. That is, in the third embodiment, rubber sheets 19 and 20 wrapping the outer winding edge 9AE and inner winding edge 9BE of the chafer 9 respectively are provided in place of the rubber sheets 15 and 16 in the first embodiment, as shown in FIG. 7 and FIG. 8.

In detail, the outer rubber sheet 19 is folded so as to wrap the outer winding edge 9AE of the chafer 9 from the outside of a radial direction. Therefore, the rubber sheet 19 is provided on both bead filler 8 side and rubber chafer 10 side of the outer winding edge 9AE. The inner rubber sheet 20 is folded so as to wrap the inner winding edge 9BE of the chafer 9 from the outside of a radial direction. Therefore, the rubber sheet 20 is provided on both bead filler 8 side and inner liner 12 side of the inner winding edge 9BE.

In the third embodiment, separation due to strain generated in the edges 9AE and 9BE of the chafe 9 can be more effectively suppressed by using rubber sheets prepared using the same wet masterbatch as in the first embodiment as the rubber sheets 19 and 20, coupled with the form of the rubber sheets 19 and 20 that wrap those edges. Other structures in the third embodiment are the same as in the first embodiment, and the description thereof is omitted.

### Fourth Embodiment

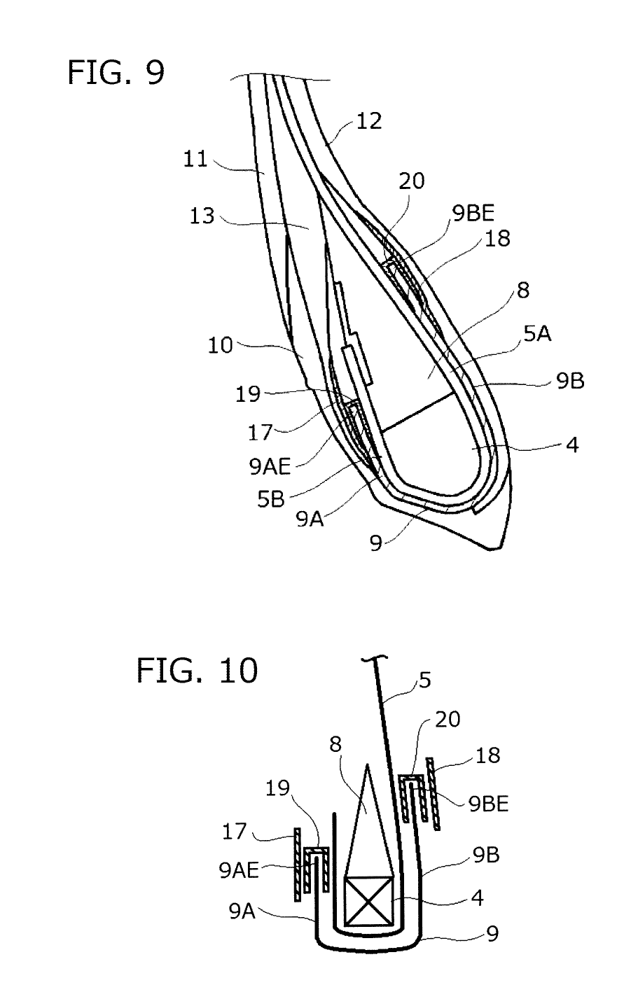

The fourth embodiment has a structure in which the second rubber sheets 17 and 18 in the second embodiment are added to the structure of the third embodiment. In detail, the first rubber sheet 19 having a form of wrapping the outer winding edge 9AE of the chafer 9 is provided, and additionally, the second rubber sheet 17 is adhered so as to cover the outside in a width direction thereof, as shown in FIG. 9 and FIG. 10. Furthermore, the first rubber sheet 20 having a form of wrapping the inner winding edge 9BE of the chafer 9 is provided, and additionally, the second rubber sheet 18 is adhered so as to cover the inside in a width direction thereof.

Thus, separation due to strain generated in the edges 9AE and 9BE of the chafer 9 can be more effectively suppressed by combining the second embodiment with the third embodiment. Other structures in the fourth embodiment are the same as in the second embodiment and third embodiment, and the description thereof is omitted.

### Fifth Embodiment

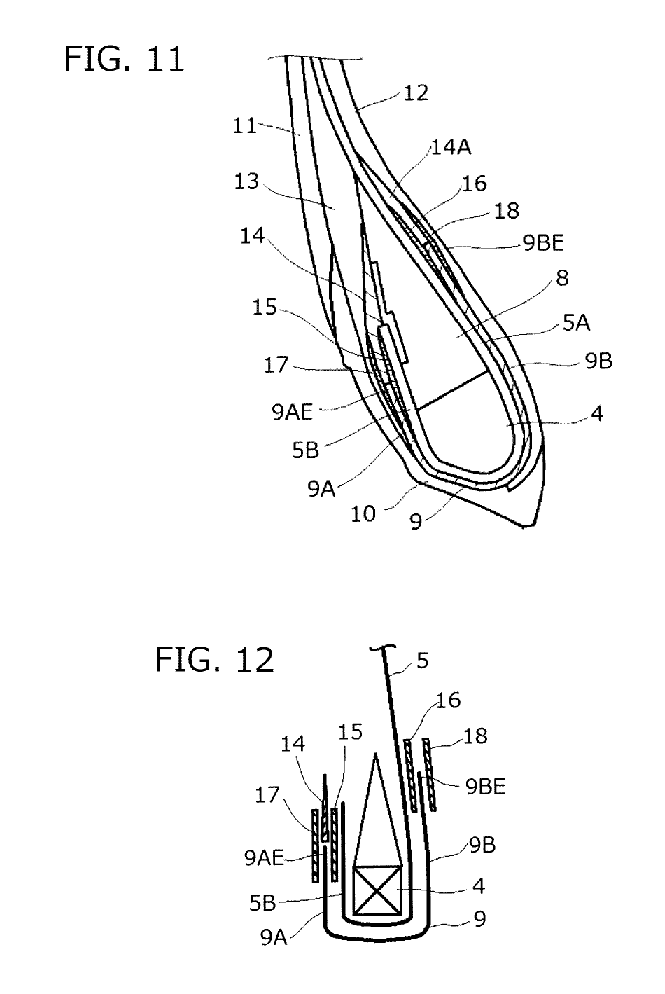

The fifth embodiment shown in FIG. 11 and FIG. 12 is an example that a rubber pad prepared using the same wet masterbatch as in the first embodiment is used as a rubber pad 14 filling level difference on the outside in a radial direction of the outer winding edge 9AE of the chafer 9, in the structure of the second embodiment. Thus, separation due to strain generated in the edge 9AE of the chafer 9 can be more effectively suppressed by using the rubber composition having improved fatigue resistance performance by highly dispersing carbon black therein also in the rubber pad 14 arranged on the outside in a radial direction of the outer winding edge 9AE of the chafer 9. Other structures in the fifth embodiment are the same as in the second embodiment, and the description thereof is omitted.

The rubber pad prepared using the same wet masterbatch as in the first embodiment may be used also as a rubber pad 14A filling level difference on the outside in a radial direction of the inner winding edge 9BE of the chafer 9.

### Method for Manufacturing Pneumatic Tire

A method for manufacturing a pneumatic tire according to the embodiment is described below together with a method for preparing a rubber composition forming the first and second rubber sheets 15 to 20 of the above each embodiment and the rubber pad 14 of the fifth embodiment (hereinafter simply referred to as a rubber sheet, but the same applies to the rubber pad).

The pneumatic tire of the present embodiment is obtained by preparing the rubber sheet using wet masterbatch containing natural rubber and/or polyisoprene rubber, and carbon black, placing the rubber sheet at the predetermined position to prepare a green tire, and vulcanization-molding the green tire. Each step is described in detail below.

### Preparation Step of Wet Masterbatch

The wet masterbatch can be prepared using a rubber latex liquid containing natural rubber (NR) and/or polyisoprene rubber (IR) and a slurry of carbon black, and the preparation method is not particularly limited. The wet masterbatch is generally obtained by mixing a slurry obtained by dispersing carbon black in a dispersion solvent, and a rubber latex liquid, followed by coagulating and drying.

A latex liquid of polyisoprene rubber as a synthetic rubber may be used as the rubber latex liquid, but a natural rubber latex liquid is preferably used (the case of NR that is a preferred embodiment is described below, but the same can be applied to the case of IR). Concentrated latex or fresh latex called field latex can be used as the natural rubber latex liquid, and as necessary, a liquid in which a concentration has been adjusted by adding water may be used. A diene rubber latex liquid other than the natural rubber and/or polyisoprene rubber may be concurrently used in a range that the effect is not impaired.

Examples of the carbon black that can be used include SAF grade (N100 Series), ISAF grade (N200 Series), HAF grade (N300 Series), FEF grade (N500 Series) and GPF grade (N600 Series) (all is ASTM grade), and of those, carbon black of HAF grade is preferably used.

The wet masterbatch preparation step according to the preferred embodiment includes (A) a step of preparing a slurry containing carbon black having rubber latex particles adhered thereto by adding a part of a natural rubber latex liquid at the time of dispersing the carbon black into a dispersion solvent, (B) a step of mixing the slurry with the remaining rubber latex liquid to prepare a carbon black-containing rubber latex liquid which contains the carbon black having the rubber latex particles adhered thereto, and (C) a step of coagulating the carbon black-containing rubber latex liquid by adding an acid.

### (1) Step (A)

In the step (A), the natural rubber latex liquid is previously mixed with a dispersion solvent, and then carbon black may be added to the resulting mixture and dispersed therein. Carbon black is added to the dispersion solvent, and then carbon black may be dispersed in the dispersion solvent while adding the natural rubber latex liquid in a predetermined addition rate. Alternatively, carbon black is added to the dispersion solvent, and then the carbon black may be dispersed in the dispersion solvent while adding a given amount of the natural rubber latex liquid in several portions. The slurry containing carbon black having natural rubber latex particles adhered thereto can be produced by dispersing carbon black in the dispersion solvent in the state that the natural rubber latex liquid is present. Water is preferably used as the dispersion solvent, but, for example, water containing an organic solvent may be used.

The amount of the natural rubber latex liquid added in the step (A) is from 0.5 to 50 mass % based on the entire amount of the natural rubber latex liquids used (the entire amount added in the step (A) and the step (B). The amount of the solid content (rubber) in the natural rubber latex liquid added in the step (A) is preferably from 0.5 to 10%, and more preferably from 1 to 6%, in mass ratio to carbon black.

The method for mixing carbon black with the dispersion solvent in the presence of the natural rubber latex liquid in the step (A) includes a method of dispersing carbon black using an ordinary disperser such as a high shear mixer, a homomixer, a ball mill, a bead mill, a high pressure homogenizer, an ultrasonic homogenizer or a colloid mill.

In one embodiment, pH of the slurry containing carbon black having the rubber latex particles adhered thereto obtained after the step (A) is preferably adjusted to 7.1 or higher. Adsorption and coagulation of the rubber latex particles adhered to the surface of carbon black to each other can be made difficult to occur by adjusting the pH to 7.1 or higher. As a result, the rubber latex can be coagulated while maintaining increased dispersibility of the carbon black, and fatigue resistance performance of the rubber sheet can be improved. Although not particularly limited, the pH adjustment method of the slurry includes a method of adjusting pH by adding a base such as sodium hydroxide, potassium hydroxide, sodium carbonate, sodium bicarbonate or ammonia to the slurry. The upper limit of pH of the slurry obtained after the step (A) is not particularly limited, and may be, for example, 9.0 or lower.

### (2) Step (B)

In the step (B), the method of mixing the slurry with the remaining natural rubber latex liquid in a liquid phase is not particularly limited, and includes a mixing method of using a ordinary disperser such as a high shear mixer, a homomixer, a ball mill, a bead mill, a high pressure homogenizer, an ultrasonic homogenizer or a colloid mill. As necessary, the entire mixing system such as a disperser may be warmed in mixing.

The remaining natural rubber latex liquid preferably has the solid content (rubber) concentration higher than that in the natural rubber latex liquid added in the step (A). Specifically, the solid content (rubber) concentration is preferably from 10 to 60 mass %, and more preferably from 20 to 30 mass %.

### (3) Step (C)

In the step (C), examples of the acid acting as a coagulating agent include formic acid and sulfuric acid that are generally used for coagulation of a rubber latex liquid.

In the step (C), the pH of the carbon black-containing rubber latex liquid before adding an acid is adjusted to preferably from 7.5 to 8.5, and more preferably from 8.0 to 8.5. By this adjustment, the rubber latex can be coagulated while maintaining increased dispersibility of carbon black. In detail, when the pH is 7.5 or higher, self-coagulation of the rubber latex particles in the rubber latex liquid can be suppressed, and fatigue resistance performance of the rubber sheet can be improved. Furthermore, when the pH is 8.5 or lower, minus charges of the charged rubber latex particles are prevented from becoming too large, and affinity with the carbon black particles can be enhanced. As a result, dispersibility of carbon black can be increased, thereby improving fatigue resistance performance. Examples of the method for adjusting pH include a method of appropriately performing heating and devolatilization under reduced pressure of a mixed liquid obtained in producing the carbon black-containing rubber latex liquid in the step (B), and a method of adding a pH regulator such as citric acid, lactic acid or sodium bicarbonate.

After the coagulation stage in the step (C), the liquid containing a coagulated material is dewatered and dried to obtain a wet masterbatch. Various drying apparatuses such as an oven, a vacuum dryer or an air dryer may be used for the dewatering and drying method, and the dewatering and drying may be performed while applying mechanical shearing force using an extruder.

The wet masterbatch obtained after the step (C) contains carbon black in an amount of preferably from 30 to 100 parts by mass, and more preferably from 40 to 80 parts by mass, per 100 parts by mass of the natural rubber.

A peptizer may be added in the step of preparing a wet masterbatch using a natural rubber latex liquid and a carbon black slurry. By adding the peptizer, carbon black can be further highly dispersed, and fatigue resistance performance of the rubber sheet can be further improved. A material generally used as a peptizing agent (peptizer) can be used as the peptizer, and examples of the peptizer include xylylmercaptan β-naphthylmercaptan, 2,2-dibenzamidodiphenyl disulfide and zinc salt of o-benzamidothiophenol, and those can be used in any one kind or as a combination of two or more kinds.

The peptizer may be previously added to the natural rubber latex liquid, may be previously added to the carbon black slurry (may be added at the time of preparation of the slurry in the step (A)), and may be added during or after mixing the natural rubber latex liquid with the carbon black slurry. The amount of the peptizer added is not particularly limited, and may be, for example, from 0.01 to 2.0 parts by mass, and may be from 0.5 to 1.0 part by mass, per 100 parts by mass of the natural rubber.

The wet masterbatch may contain various additives generally used in rubber industries so long as the effect of the present embodiment is not impaired.

### Rubber Sheet Preparation Step

In the rubber sheet preparation step, a rubber sheet is prepared from the rubber composition containing the wet masterbatch obtained. The rubber composition for a rubber sheet can contain various additives such as a vulcanizing agent, a vulcanization accelerator, silica, a silane coupling agent, zinc oxide, stearic acid, an age resistor, a softener such as a wax or an oil, and a processing aid, in addition to the wet masterbatch.

Examples of the vulcanizing agent include sulfur components such as powdered sulfur, precipitated sulfur, colloidal sulfur, insoluble sulfur and highly dispersive sulfur. Although not particularly limited, the amount of the vulcanizing agent added is preferably from 0.5 to 10 parts by mass, and more preferably from 1 to 6 parts by mass, per 100 parts by mass of the rubber component. The amount of the vulcanization accelerator added is preferably from 0.1 to 7 parts by mass, and more preferably from 0.5 to 5 parts by mass, per 100 parts by mass of the rubber component.

In the rubber composition, the rubber component may be only natural rubber and/or polyisoprene rubber to be added as a wet masterbatch, but other diene rubbers may be added in a range that the effect is not impaired. The amount of the natural rubber and/or polyisoprene rubber added is preferably 50 parts by mass or more, more preferably 80 parts by mass or more, and particularly preferably 100 parts by mass, in 100 parts by mass of the rubber component.

In the rubber composition, it is preferred that the entire amount of the carbon black is added as a wet masterbatch. The amount of the carbon black added in the rubber composition is preferably from 30 to 100 parts by mass, and more preferably from 40 to 80 parts by mass, per 100 parts by mass of the rubber component.

The rubber composition may further contain a phenol type thermosetting resin and a methylene donor as a hardener thereof. Examples of the phenol type thermosetting resin include resins obtained by condensing at least one of phenol compounds selected from the group consisting of phenol, resorcin and their alkyl derivatives with aldehyde such as formaldehyde. Examples of the alkyl derivatives include cresol, xylenol, nonylphenol and octylphenol. Specific examples of the phenol type thermosetting resin include various novolac phenol resins such as an unmodified phenol resin obtained by condensation of phenol and formaldehyde, an alkyl-substituted phenol resin obtained by condensation of an alkyl phenol such as cresol or xylenol, and formaldehyde, a resorcin-formaldehyde resin obtained by condensation of resorcin and formaldehyde, and a resorcin-alkyl phenol cocondensated formaldehyde resin obtained by condensation of resorcin, alkyl phenol and formaldehyde.

Hexamethylenetetramine and/or melamine derivative are used as the methylene donor added as a hardener of the phenol type thermosetting resin. Examples of the melamine derivative include at least one selected from the group consisting of hexamethoxymethylmelamine, hexamethylolmelamine pentamethyl ether and polyhydric methylolmelamine.

The amount of the phenol type thermosetting resin added is preferably from 0.5 to 10 parts by mass, and more preferably from 1 to 5 parts by mass, per 100 parts by mass of the rubber component. The amount of the melamine donor added is preferably from 0.5 to 10 parts by mass, and more preferably from 1 to 5 parts by mass, per 100 parts by mass of the rubber component.

The rubber composition can be prepared by kneading the necessary components according to the conventional method using a mixing machine generally used, such as Banbury mixer, a kneader or rolls. As a method of preparing the rubber sheet using the rubber composition obtained, the rubber composition is formed into a sheet using, for example, an extruder. The thickness of the rubber sheets 15 to 20 is not particularly limited. From the standpoint of fatigue resistance performance, the thickness is preferably 0.1 mm or more, more preferably from 0.3 to 5.0 mm, and still more preferably from 0.5 to 2.0 mm. The thickness of the rubber pad 14 is not particularly limited.

### Green Tire Manufacturing Step

The conventional forming method using a forming drum can be used for the preparation method of a green tire (unvulcanized tire). For example, an inner liner and a carcass ply are attached to a forming drum. A bead core, a bead filler and a chafer are mounted on both edges of the carcass ply. The both edges of the carcass ply are folded around the bead core together with the chafer. A rubber chafer, a sidewall rubber and the like are then attached. A diameter of the forming drum is expanded, and a belt layer and a tread rubber are attached to a crown part of the carcass ply. Thus, a green tire can be formed.

In the present embodiment, when preparing the green tire, at least one member of the unvulcanzied rubber sheets 15 to 20 and the rubber pad 14 is adhered to the predetermined positions including the position between the folded part 5B of the carcass ply 5 and the outer winding edge 9AE of the chafer 9 in winding and folding the carcass ply 5 together with the chafer 9.

### Vulcanization Molding Step

In the vulcanization molding step, the green tire obtained above is vulcanization-molded. The conventional method is applicable to the vulcanization molding. That is, according to the conventional, method, the green tire is set in a vulcanization mold and vulcanization-molded at a temperature of, for example, from 140 to 180° C., thereby a pneumatic tire according to the embodiment is obtained.

In the present embodiment comprising the above, carbon black is highly dispersed in the rubber sheets 15 to 20 and the rubber pad 14, and by arranging the rubber sheets and rubber pad at the predetermined positions including the position between the folded part 5B of the carcass ply 5 and the outer winding edge 9AE of the chafer 9, separation due to local strain fatigue in the winding edge can be effectively suppressed. The present embodiment can be used in various pneumatic tires, and is preferably applied to a tire for heavy load used in large-sized vehicles such as trucks or buses, in which separation is likely to become problem.

### EXAMPLES

Examples of the invention are described below, but the invention is not construed as being limited to those examples. Raw materials used and evaluation methods are as follows.

### Raw Materials Used

Carbon black: N330, “SEAST 3” manufactured by Tokai Carbon Co., Ltd.

Natural rubber latex liquid: Natural rubber concentrated latex liquid “LA-NR” (DRC (Dry Rubber Content)=60%) manufactured by Regitex Co., Ltd.

Coagulating agent: Formic acid (first grade 85%, diluted to 10% solution and adjusted to pH 1.2) manufactured by Nacalai Tesque, Inc.

Peptizer: “NOCTIZER SD” manufactured by Ouchi Shinko Chemical Industrial Co., Ltd.

Phenol resin: Resorcin-alkyl phenol-formalin copolymer resin, “SUMIKANOL 620” manufactured by Sumitomo Chemical Co., Ltd.

Zinc flower: “Zinc Flower #3” manufactured by Mitsui Mining & Smelting Co., Ltd.

Age resister: N-phenyl-N′-(1,3-dimethylbutyl)-p-phenylenediamine, “6PPD” manufactured by Monsanto Company.

Insoluble sulfur: “CRYSTEX OT-20” manufactured by Akzo.

Vulcanization accelerator: Sulfenamide type, N,N-dicyclohexyl-2-benzothiazolyl sulfenamide, “NOCCELER DZ-G” manufactured by Ouchi Shinko Chemical Industrial Co., Ltd.

Methylene donor: Hexamethoxymethylmelamine, “CYLET 963L” manufactured by Nihon Cytec Industries Inc.

### Measurement and Evaluation Methods

pH: Evaluated according to JIS Z8802 using a portable pH meter HM-30P, manufactured by DKK-TOA corporation. The pH measurement of the slurry obtained in the step (A) was conducted under the condition of 25° C., and the pH measurement of the carbon black-containing rubber latex liquid before adding the acid in the step (C) was conducted at a liquid temperature of the mixed liquid shown in Table 1.

Fatigue resistance performance: Evaluated according to JIS K6260. The measurement was conducted under the condition of a temperature of 23° C., and the number until crack growth reaches 2 mm was obtained. The fatigue resistance performance is indicated by an index as the value of Comparative Example 1 being 100, and the larger the numerical value of the index, the better the fatigue resistance performance is.

Tire durability: A trial tire was run on a drum testing machine under the conditions of air inner pressure: 0.9 MPa, load: 53 kN, and speed: 40 km/h until tire failure occurs. Running time until failure of a bead part occurs was indicated by an index as the value of Comparative Example 1 being 100. The larger the numerical value, the longer and the better the running time until failure of a bead part occurs. When the numerical value is 110 or higher, it can be said that durability improvement effect is high.

### Arrangement of Rubber Sheet and the Like

Mounting position a: The position of the rubber sheets 15 and 16 in the first embodiment. Overall width is 25 mm (15 mm toward a tread side and 10 mm toward a bead toe side from the winding edge of the chafer) (thickness: 1.5 mm). Arranged over the entire circumference in a tire circumferential direction.

Mounting position b: The position of the rubber sheet 17 in the second embodiment. Overall width is 45 mm (30 mm toward a tread side and 15 mm toward a bead toe side from the outer winding edge of the chafer) (thickness: 1.5 mm). Arranged over the entire circumference in a tire circumferential direction.

Mounting position c: The position of the rubber sheet 18 in the second embodiment. Overall width is 45 mm (30 mm toward a tread side and 15 mm toward a bead toe side from the inner winding edge of the chafer) (thickness: 1.5 mm). Arranged over the entire circumference in a tire circumferential direction.

Mounting position d: The position of the rubber sheet 19 in the third embodiment. Folded so as to wrap an outer winding edge of a chafer (overall width is 20 mm of 10 mm at a bead filler side and 10 mm at a rubber chafer side, toward a bead toe side from an outer winding edge, thickness: 0.5 mm), and arranged over the entire circumference in a tire circumferential direction.

Mounting position e: The position of the rubber sheet 20 in the third embodiment. Folded so as to wrap an inner winding edge of a chafer (overall width is 20 mm of 10 mm at a bead filler side and 10 mm at an inner liner side, toward a bead toe side from an inner winding edge, thickness: 0.5 mm), and arranged over the entire circumference in a tire circumferential direction.

Mounting position f: A material prepared using a wet masterbatch is used as the rubber pad 14, corresponding to the fifth embodiment.

### Example 1

Carbon black (50 parts by mass) was added to a natural rubber latex liquid (954.8 parts by mass) in which a concentration of a solid content (rubber) had been adjusted to 0.5 mass %, and the carbon black was dispersed using ROBOMIX manufactured by Primix Corporation (conditions of the ROBOMIX: 50° C., 9,000 rpm, 30 minutes) to produce a slurry containing the carbon black having natural rubber latex particles adhered thereto (step A). The pH of the slurry obtained in the step A is shown in Table 1. The amount of the 0.5 mass % natural rubber latex liquid used was set such that the amount of the carbon black based on the total amount of water and the carbon black was 5 mass % in the slurry obtained in the step A (the same is applied to the wet masterbatch preparation step in the following examples).

The remaining natural rubber latex liquid (a liquid adjusted by adding water at a temperature of 25° C. such that the concentration of the solid content is 25 mass %) was added to the slurry produced in the step A such that the amount of the solid content was 100 parts by mass in combination with the natural rubber latex liquid used in the step A. The resulting liquid was mixed using a household mixer SM-L56 manufactured by Sanyo Electric Co., Ltd. (mixer conditions: 11,300 rpm, 30 minutes) to produce a carbon black-containing natural rubber latex liquid (step B). The pH of the natural rubber latex liquid added in the step B is shown in Table 1.

The carbon black-containing natural rubber latex liquid produced in the step B was heated so as to reach a liquid temperature of a mixed liquid shown in Table 1, and the pH of the carbon black-containing natural rubber latex liquid before coagulation was adjusted to the value shown in Table 1. 10 mass % aqueous solution of formic acid was added as a coagulating agent until the pH reached 4 (step C). After solid-liquid separation of a coagulated material, the coagulated material was dehydrated using a squeezer type single screw extrusion dehydrator (V-02 Model manufactured by Suehiro EPM Corporation) (180° C.), and the coagulated material was dried and plasticized to a moisture content of 1.5% or less using the extrusion dehydrator (200° C.) to obtain a wet masterbatch. The wet masterbatch contains carbon black in an amount of 50 parts by mass per 100 parts by mass of natural rubber, as shown in masterbatch formulation of Table 1.

According to the rubber composition formulation in Table 1, components excluding sulfur, a vulcanization accelerator and a methylene donor were added to the wet masterbatch, followed by mixing (discharge temperature: 160° C.) using B type Banbury mixer (manufactured by Kobe Steel, Ltd.) in a first step (non-processing mixing step). Sulfur, a vulcanization accelerator and a methylene donor were then added to the mixture obtained, followed by mixing (discharge temperate: 100° C.) in a second step (final mixing step). Thus, a rubber composition was prepared.

A rubber sheet was prepared from the rubber composition obtained. A pneumatic radial tire for heavy load (tire size: 11R22.5; a reinforcing cord is a steel cord in the carcass ply 5 and the chafer 9) corresponding to the first embodiment was obtained by vulcanization molding using the rubber sheet as the rubber sheets 15 and 16 (mounting position a) shown in FIG. 2.

### Examples 2 to 8

Wet masterbatches were prepared by the same method as in Example 1, except for changing the amount of carbon black added in the step A, the pH of the carbon black-containing slurry obtained after the step A, the pH of the natural rubber latex liquid added in the step B, the liquid teurperature of the carbon black-containing natural rubber latex liquid prepared in the step (B) (the liquid temperature of the mixed liquid), and the pH of the carbon black-containing natural rubber latex liquid before coagulation in the step C to the values shown in Table 1. Rubber compositions were prepared in the same manners as in Example 1 using the wet masterbatches obtained and according to the rubber composition formulation in Table 1, rubber sheets were prepared using the rubber compositions, and trial tires were prepared using the rubber sheets.

### Examples 9 to 12

Trial tires were manufactured in the same manner as in Example 1, except for changing the arrangement of the rubber sheet and the like as shown in Table 1 (each rubber sheet and the like of a to f in the table were prepared using the rubber composition obtained in Example 1). In detail, Example 9 is an example corresponding to the second embodiment, Example 10 is an example corresponding to the third embodiment, Example 11 is an example corresponding to the fourth embodiment, and Example 12 is an example corresponding to the fifth embodiment.

### Example 13

A wet masterbatch, a rubber composition and a rubber sheet were prepared in the same manners as in Example 1, except for adding a peptizer in an amount of 0.1 parts by mass per 100 parts by mass of natural rubber in mixing the slurry with the remaining natural rubber latex liquid in the step B, and a trial tire was manufactured using those.

### Comparative Examples 1 and 2

A rubber composition was prepared by dry mixing according to the rubber composition formulations shown in Table 1 without preparing a wet masterbatch. A rubber sheet was prepared using the rubber composition, and a trial tire was manufactured, in the same manners as in Example 1. The dry masterbatch in Comparative Example 2 is a masterbatch obtained by adding 50 parts by mass of carbon black to 100 parts by mass of natural rubber, followed by kneading using B Type Banbury mixer (manufactured by Kobe Steel, Ltd.). In Comparative Examples 1 and 2, RSS #3 was used as the natural rubber.

### Comparative Examples 3 and 4

Trial tires were manufactured in the same manner as in Example 1, except for changing the arrangement of a rubber sheet and the like as shown in Table 1. In detail, Comparative Example 3 is an example that the first rubber sheets 15 and 16 and the second rubber sheet 18 were omitted in the second embodiment shown in FIG. 5 and FIG. 6, and Comparative Example 4 is an example that the first rubber sheets 15 and 16 were omitted in the second embodiment.

Fatigue resistance performance of each robber composition obtained above was evaluated using a test piece obtained by vulcanizing each rubber composition at 150° C. for 30 minutes, and drum durability of each trial tire was evaluated. The results obtained are shown in Table 1.

As shown in Table 1, in Comparative Example 2 in which a dry masterbatch was prepared using natural rubber, the improvement effect of fatigue resistance performance was small and the improvement effect of drum durability was also small as compared with Comparative Example 1 as a control. On the other hand, in Examples 1 to 13 in which the rubber sheet prepared using a wet masterbatch was arranged in the predetermined positions including a position between a folded portion of a carcass ply and the winding edge of a chafer, fatigue resistance performance of fhe rubber sheet was excellent, and as a result, drum durability was improved. Particularly, fatigue resistance performance of the rubber sheet was remarkably improved in Examples 1 to 4 and 9 to 13. Drum durability was remarkably improved in Examples 10 and 11 in which the rubber sheet was arranged so as to wrap the edge of a chafer and Example 12 corresponding to the fifth embodiment. Fatigue resistance performance of the rubber sheet was further improved and drum durability was excellent in Example 13 in which a peptizer was added in preparing a wet masterbatch. On the other hand, the improvement effect of drum durability was small in Comparative Examples 3 and 4 in which a rubber sheet having excellent fatigue resistance performance prepared using a wet masterbatch was used, but was not arranged between a carcass ply and the winding edge of a chafer.

TABLE 1

| | Comparative | Comparative | Comparative | Comparative | | | | |
|---|---|---|---|---|---|---|---|---|
| | Example 1 | Example 2 | Example 3 | Example 4 | Example 1 | Example 2 | Example 3 | Example 4 |
| Wet masterbatch preparation conditions | | | | | | | | |
| pH of carbon black-containing slurry | — | — | 7.3 | 7.3 | 7.3 | 7.3 | 7.3 | 7.3 |
| pH of natural rubber latex liquid | — | — | 10.4 | 10.4 | 10.4 | 9.6 | 9.1 | 10.4 |
| Liquid temperature of mixed liquid (° C.) | — | — | 83 | 83 | 83 | 60 | 61 | 83 |
| pH of carbon black-containing natural rubber | — | — | 8.3 | 8.3 | 8.3 | 8.1 | 8.1 | 8.3 |
| latex liquid before coagulation | | | | | | | | |
| Wet masterbatch composition | | | | | | | | |
| (parts by mass) | | | | | | | | |
| Natural rubber (solid content) | — | — | 100 | 100 | 100 | 100 | 100 | 100 |
| Carbon black | — | — | 50 | 50 | 50 | 50 | 50 | 45 |
| Peptizer | — | — | — | — | — | — | — | — |
| Rubber composition formulation | | | | | | | | |
| (parts by mass) | | | | | | | | |
| Natural rubber | 100 | — | — | — | — | — | — | — |
| Carbon black | 50 | — | — | — | — | — | — | 5 |
| Dry masterbatch | — | 150 | — | — | — | — | — | — |
| Wet masterbatch | — | — | 150 | 150 | 150 | 150 | 150 | 145 |
| Zinc flower | 8 | 8 | 8 | 8 | 8 | 8 | 8 | 8 |
| Phenol resin | 2 | 2 | 2 | 2 | 2 | 2 | 2 | 2 |
| Age resister | 2 | 2 | 2 | 2 | 2 | 2 | 2 | 2 |
| Insoluble sulfur | 4.5 | 4.5 | 4.5 | 4.5 | 4.5 | 4.5 | 4.5 | 4.5 |
| Vulcanization accelerator | 1 | 1 | 1 | 1 | 1 | 1 | 1 | 1 |
| Methylene donor | 4 | 4 | 4 | 4 | 4 | 4 | 4 | 4 |
| Arrangement of rubber sheet and the like | a | a | b | b + c | a | a | a | a |
| | (FIG. 4) | (FIG. 4) | | | (FIG. 4) | (FIG. 4) | (FIG. 4) | (FIG. 4) |
| Evaluation | | | | | | | | |
| Fatigue resistance performance (index) | 100 | 105 | 137 | 137 | 137 | 137 | 137 | 130 |
| Tire durability | 100 | 104 | 106 | 107 | 114 | 113 | 113 | 111 |

| | | | | | | Example | Example | Example | Example |
|---|---|---|---|---|---|---|---|---|---|
| | Example 5 | Example 6 | Example 7 | Example 8 | Example 9 | 10 | 11 | 12 | 13 |
| Wet masterbatch preparation | | | | | | | | | |
| conditions | | | | | | | | | |
| pH of carbon black-containing slurry | 7.3 | 7.3 | 5.3 | 6.5 | 7.3 | 7.3 | 7.3 | 7.3 | 7.3 |
| pH of natural rubber latex liquid | 10.4 | 10.4 | 10.4 | 10.4 | 10.4 | 10.4 | 10.4 | 10.4 | 10.4 |
| Liquid temperature of mixed | 60 | 98 | 35 | 63 | 83 | 83 | 83 | 83 | 83 |
| liquid (° C.) | | | | | | | | | |
| pH of carbon black-containing | 9.0 | 7.1 | 7.2 | 7.3 | 8.3 | 8.3 | 8.3 | 8.3 | 8.3 |
| natural rubber latex liquid before | | | | | | | | | |
| coagulation | | | | | | | | | |
| Wet masterbatch composition | | | | | | | | | |
| (parts by mass) | | | | | | | | | |
| Natural rubber (solid content) | 100 | 100 | 100 | 100 | 100 | 100 | 100 | 100 | 100 |
| Carbon black | 50 | 50 | 50 | 50 | 50 | 50 | 50 | 50 | 50 |
| Peptizer | — | — | — | — | — | — | — | — | 0.1 |
| Rubber composition formulation | | | | | | | | | |
| (parts by mass) | | | | | | | | | |
| Natural rubber | — | — | — | — | — | — | — | — | — |
| Carbon black | — | — | — | — | — | — | — | — | — |
| Dry masterbatch | — | — | — | — | — | — | — | — | — |
| Wet masterbatch | 150 | 150 | 150 | 150 | 150 | 150 | 150 | 150 | 150 |
| Zinc flower | 8 | 8 | 8 | 8 | 8 | 8 | 8 | 8 | 8 |
| Phenol resin | 2 | 2 | 2 | 2 | 2 | 2 | 2 | 2 | 2 |
| Age resister | 2 | 2 | 2 | 2 | 2 | 2 | 2 | 2 | 2 |
| Insoluble sulfur | 4.5 | 4.5 | 4.5 | 4.5 | 4.5 | 4.5 | 4.5 | 4.5 | 4.5 |
| Vulcanization accelerator | 1 | 1 | 1 | 1 | 1 | 1 | 1 | 1 | 1 |
| Methylene donor | 4 | 4 | 4 | 4 | 4 | 4 | 4 | 4 | 4 |
| Arrangement of rubber sheet and | a | a | a | a | a + b + c | d + e | b + c + d + e | a + b + c + f | a |
| the like | (FIG. 4) | (FIG. 4) | (FIG. 4) | (FIG. 4) | (FIG. 6) | (FIG. 8) | (FIG. 10) | (FIG. 12) | (FIG. 4) |
| Evaluation | | | | | | | | | |
| Fatigue resistance performance | 112 | 115 | 113 | 115 | 137 | 137 | 137 | 137 | 150 |
| (index) | | | | | | | | | |
| Tire durability | 111 | 111 | 111 | 112 | 116 | 121 | 123 | 142 | 118 |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for manufacturing a pneumatic tire comprising:
preparing a rubber sheet using a wet masterbatch containing natural rubber and/or polyisoprene rubber, and carbon black;
in preparing a green tire in which the edge of a carcass ply is folded around a bead core and a chafer having a reinforcing cord embedded therein is arranged so as to cover the carcass ply around the bead core, interposing the rubber sheet between the folded part of the carcass ply and the edge of the chafer overlapping the folded part; and
vulcanization-molding the green tire obtained.

2. The method for manufacturing a pneumatic tire according to claim 1, wherein a peptizer is added in the step of preparing the wet masterbatch using a rubber latex liquid containing natural rubber and/or polyisoprene rubber and a slurry of carbon black.

3. The method for manufacturing a pneumatic tire according to claim 1, wherein the step of preparing the wet masterbatch comprises:
a step (A) of, at the time of dispersing the carbon black into a dispersion solvent, adding a part of a rubber latex liquid containing natural rubber and/or polyisoprene rubber thereto, thereby preparing a slurry containing the carbon black to which rubber latex particles adhere;
a step (B) of mixing the slurry with the remaining rubber latex liquid, thereby preparing a carbon black-containing rubber latex liquid which contains the carbon black having rubber latex particles adhered thereto; and
a step (C) of coagulating the carbon black-containing rubber latex liquid by adding an acid thereto,
wherein the pH of the carbon black-containing rubber latex liquid before adding the acid in the step (C) is adjusted to from 7.5 to 8.5.

4. The method for manufacturing a pneumatic tire according to claim 3, wherein the pH of the slurry containing the carbon black having rubber latex particles adhered thereto obtained after the step (A) is adjusted to 7.1 or higher.

5. The method for manufacturing a pneumatic tire according to claim 1, wherein the rubber sheet prepared using the wet masterbatch is further interposed between a main part of the carcass ply and the edge of the chafer overlapping the main part in preparing the green tire.

6. The method for manufacturing a pneumatic tire according to claim 1, wherein the rubber sheet is used as a first rubber sheet, a second rubber sheet is prepared using the wet masterbatch, and the second rubber sheet is arranged such that the edge of the chafer is sandwiched between the first rubber sheet and the second rubber sheet.

7. The method for manufacturing a pneumatic tire according to claim 1, wherein the rubber sheet is arranged so as to wrap the edge of the chafer.

8. The method for manufacturing a pneumatic tire according to claim 1, wherein a rubber pad prepared using the wet masterbatch is arranged so as to fill level difference on the outside in a tire radial direction of the edge of the chafer.

9. A pneumatic tire comprising: a bead core embedded in a bead part; a carcass ply folded around the bead core and locked; a chafer having a reinforcing cord embedded therein arranged so as to cover the carcass ply around the bead core; and a rubber sheet interposed between the folded part of the carcass ply and the edge of chafer overlapping the folded part,
wherein the rubber sheet comprises a rubber composition comprising a wet masterbatch containing natural rubber and/or polyisoprene rubber, and carbon black.

10. The pneumatic tire according to claim 9, wherein the rubber sheet comprising the rubber composition containing the wet masterbatch is further interposed between a main part of the carcass ply and the edge of the chafer overlapping the main part.

11. The pneumatic tire according to claim 9, wherein the rubber sheet is used as a first rubber sheet, a second rubber sheet comprising the rubber composition comprising the wet masterbatch is provided, and the second rubber sheet is arranged such that the edge of the chafer is sandwiched between the first rubber sheet and the second rubber sheet.

12. The pneumatic tire according to claim 9, wherein the rubber sheet is arranged so as to wrap the edge of the chafer.

13. The pneumatic tire according to claim 9, wherein a rubber pad comprising a rubber composition comprising the wet masterbatch is arranged so as to fill level difference on the outside in a tire radial direction of the edge of the chafer.
